(19) United States
(12) Patent Application Publication
(10) Pub. No.: US 2008/0277263 A1
(43) Pub. Date: Nov. 13, 2008

(54) METHOD AND APPARATUS FOR TREATMENT OF IMPOTABLE WATER

(76) Inventor: Helmer C. SWENHOLT, Falls Church, VA (US)

Correspondence Address: NIXON & VANDERHYE, PC, 901 NORTH GLEBE ROAD, 11TH FLOOR, ARLINGTON, VA, 22203, US

(21) Appl. No.: 12/117,144

(22) Filed: May 8, 2008

Related U.S. Application Data
(60) Provisional application No. 60/916,579, filed on May 8, 2007.

(51) Int. Cl. C02F 1/04

(52) U.S. Cl. 203/11; 202/167

(57) ABSTRACT

Apparatus and method are provided for treatment of impotable water and for optionally simultaneously creating surplus electricity. Briefly, water is marshaled through a series of chambers by variances in pressure which are created as the water changes state from liquid to gas and from gas to liquid. The source or input water moves through the system, first heated, then vaporized where the impurities fall out, then pushed and pulled through a nozzle where it turns the blades of a turbine-type generator, and finally condensed where the newly-distilled water is removed from the system.

This application claims the priority and benefit of U.S. Provisional Patent Application 60/916,579, filed May 8, 2007, entitled “Solar Water Heater”, which is incorporated herein by reference in its entirety.

### BACKGROUND

I. Technical Field

This invention pertains to method and apparatus for treatment of impotable water, and particularly to such method and apparatus as may render impotable water suitable for uses not otherwise possible.

II. Related Art and Other Considerations

Presently the planet has an abundance of salty sea water. Without desalinization sea water is unsuited for human or livestock consumption, for most agricultural uses, and many industrial applications. Further, increasing amounts of water supplies, whether salt laden or not, are becoming polluted and also unfit for such consumption, uses, or applications.

### BRIEF SUMMARY

Apparatus and method are provided for treatment of impotable water and for optionally simultaneously creating surplus electricity. Briefly, water (initially impotable) is marshaled through a series of chambers by variances in pressure which are created as the water changes state from liquid to gas and from gas to liquid. The source water moves through the system, is first heated, then vaporized where the impurities fall out, then pushed and pulled through a nozzle where it turns the blades of a turbine-type generator, and finally condensed where the newly-distilled water is removed from the system.

Thus, in one of its aspects the technology concerns a system for treatment of impotable water. The water treatment system comprises a water heater; an inlet configured to admit the impotable water as input water from a source or body of such impotable water into the water heater; an evaporation chamber wherein the heated impotable water vaporizes to form a moist vapor; a nozzle; a condensation chamber connected to receive the moist vapor from the nozzle and to condense into treated or distilled (e.g., desalinized or purified) water; a vacuum source connected to draw the moist vapor through the nozzle and into the condensation chamber; and, a tube connected and configured to receive a recirculation portion of the treated/distilled water from the condensation chamber, to cool the recirculation portion of the treated water, and to admit the recirculation portion of the treated water into the nozzle.

In an example implementation, the evaporation chamber comprises an evaporation chamber inlet and an evaporation chamber outlet. The evaporation chamber is fed with heated water from the water heater through the evaporation chamber inlet. The evaporation chamber is configured so that the heated water vaporizes therein to form the moist vapor.

An example embodiment further comprises a system housing or container. In one example implementation, the housing is configured for at least partial submersion in a body or source of input water (e.g., salt water, muddy, or polluted water). The housing comprises a horizontal compartment and a vertical compartment. The horizontal compartment extends to a first depth relative to a surface of the body or source of input water, the vertical compartment extends to a second depth relative to a surface of the body/source of input water, the second depth being greater than the first depth. In an example embodiment, the water heater, the evaporation chamber; the nozzle, and the condensation chamber are essentially situated in the horizontal section. That is, the housing is configured to at least partially enclose the water heater, the evaporation chamber; the nozzle, the condensation chamber, the vacuum source, and the tube. At least a portion of the tube also extends through the housing and into the body/source of the input water.

In an example embodiment, the nozzle is configured to accelerate the passage of the moist vapor therethrough and comprises at least one rotatable turbine situated in the nozzle and configured to rotate and generate electricity as the moist vapor travels through the nozzle.

In an example embodiment, the water heater comprises a vacuum-tube array solar water heater.

In an example embodiment, the vacuum source comprises a Torricelli vacuum source. In such embodiment the Torricelli vacuum source comprises a column of liquid, a majority of the column of liquid being situation in the vertical section and below the first depth. As an optional feature, this embodiment may further comprise at least one valve configured to maintain the vacuum in the column of liquid.

In another of its aspects, the technology comprises a method of treating impotable water such as salt water or polluted water, for example. The method comprises the example acts of vaporizing the heated input impotable water in an evaporation chamber to form a moist vapor; transmitting the moist vapor through a nozzle and into a condensing chamber; condensing the moist vapor received from the nozzle to form treated water (e.g., desalinated or purified water) and discharging at least some of the treated water; using a vacuum source to draw the moist vapor through the nozzle and into the condensation chamber; and, recirculating and cooling a recirculated portion of the treated water from the condensation chamber and admitting the recirculation portion of the treated water into the nozzle.

In an example mode, the method further comprises using a shape of the nozzle to accelerate passage of the moist vapor through the nozzle.

In an example mode, the method further comprises situating at least one rotatable turbine in the nozzle and using the turbine to generate electricity as the moist vapor travels through the nozzle.

In an example mode, the method further comprises using a vacuum-tube array solar water heater for heating the input water.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of water treatment apparatus according to an example embodiment.

FIG. 2 is a schematic view of water treatment apparatus according to another example embodiment.

FIG. 3 is a schematic view of water treatment apparatus according to another example embodiment.

FIG. 4 is a flowchart showing example, basic acts or steps comprising a method of treating impotable water according to an example mode of operation.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Described herein are, e.g., embodiments of method and apparatus for treatment of impotable water. By “impotable” water is meant any predominately adequeous fluid that is unsuited for human or livestock consumption, for one or more agricultural uses, or for one or more industrial applications. As such “impotable” water encompasses, but is not limited to, salt water (such as obtained from oceans, for example) and polluted water.

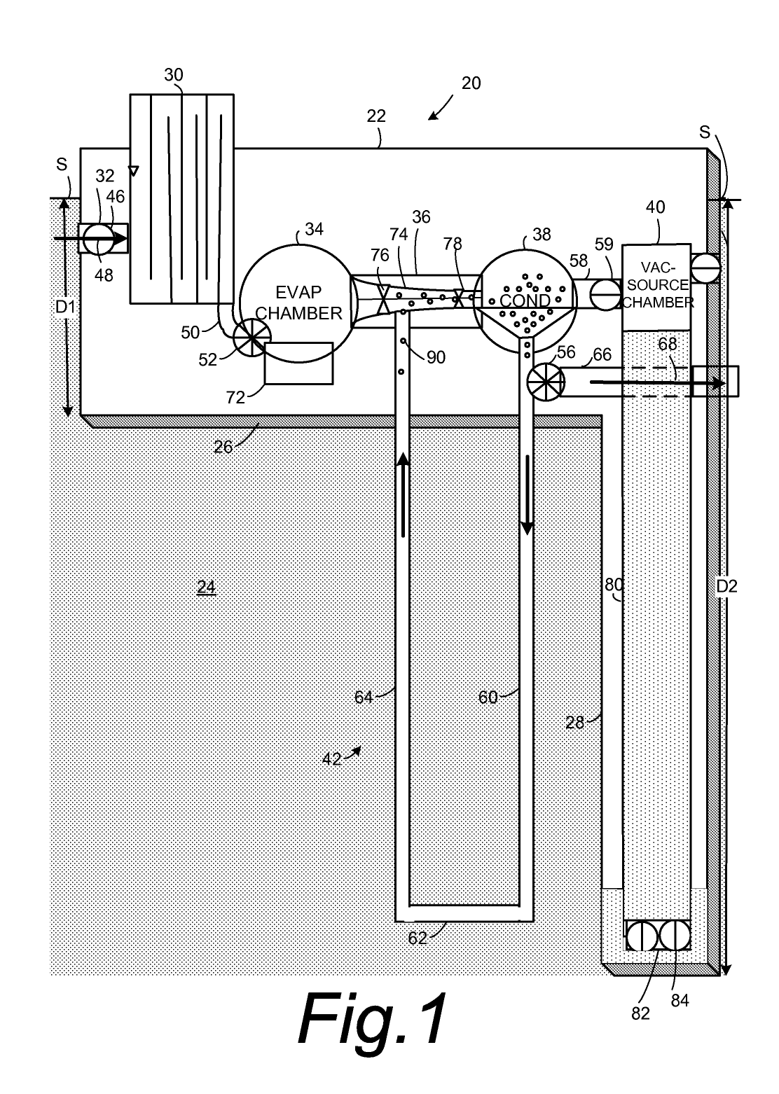

FIG. 1 shows a water treatment system 20 according to a first example embodiment. As explained subsequently, water treatment system 20 happens to be an example of a desalinization system 20, although other types of water treatment system can be similarly constructed and/or employed. The desalinization system 20 comprises a system housing or container 22. The housing 22 is configured for at least partial submersion in a source or body of salt water 24. The source or body of salt water 24 can be, for example, an ocean, bay, inlet, gulf, or any other reservoir, natural or man-made, wherein salt water resides. In FIG. 1, the body of salt water 24 is shown by stippling.

In the illustrated example implementation, housing 22 comprises housing horizontal compartment 26 and housing vertical compartment 28. The horizontal compartment 26 extends to a first depth D1 relative to a surface S of the body of salt water; the vertical compartment extends to a second depth D2 relative to the surface S of the body of salt water. The second depth D2 is greater than the first depth D1.

The desalinization system 20 of the example embodiment of FIG. 1 comprises input water heater 30; an inlet 32 for admitting input water (e.g., salt water) into system 20; evaporation chamber 34; nozzle 36; condensation chamber 38; vacuum source 40; and, recirculation tube 42. The inlet 32 is configured to admit the input water (e.g., salt water) from source/body of salt water 24 into water heater 30. Inlet valve 46 is positioned in or proximate inlet 32. The inlet valve 46 may be preceded or covered by a filter or the like for separating impurities such as solid impurities. At the time shown in FIG. 1, inlet valve 46 is open to admit the input water into an inlet of salt water heater 30, the direction of the admitted input water into the inlet of water heater 30 being depicted by arrow 48 in FIG. 1.

In the illustrated example of FIG. 1, an outlet of water heater 30 is connected to an inlet of evaporation chamber 34 through connector pipe 50 and rotary lock valve 52. In evaporation chamber 34 the heated input water vaporizes to form a moist vapor. An outlet of evaporation chamber 34 is connected to an inlet of nozzle 36. An outlet of nozzle 36 is connected to condensation chamber 38. In particular, an inlet of condensation chamber is connected to receive the moist vapor from nozzle 36 and to condense the moist vapor into treated water (e.g., desalinized water in the example of system 20). A discharge mechanism 56 is provided and configured to discharge at least some of the treated water so that the treated water can be extracted from desalinization system 20 and utilized for other purposes, e.g., for human or animal consumption, or for agricultural or industrial purposes, for example.

Vacuum source 40 is connected to draw the moist vapor from evaporation chamber 34, through nozzle 36, and into condensation chamber 38. In this regard, a port of vacuum source 40 is connected by a hose or conduit 58 to condensation chamber 38, with a valve 59 being located either in conduit 58 or proximate/in the port of the vacuum source for selective application of the vacuum to the remainder of the system. An inlet of recirculation tube 42 is connected to an outlet in a lower portion of condensation chamber 38 and configured to receive a recirculation portion of the treated water from the condensation chamber 38.

In the example embodiment of FIG. 1, water heater 30, evaporation chamber 34; nozzle 36, and condensation chamber 38 are essentially situated in the horizontal housing section 26. That is, the horizontal housing section 26 is configured to at least partially enclose water heater 30, evaporation chamber 34; nozzle 36, and condensation chamber 38. A top portion of vacuum source 40 is also included in housing horizontal compartment 26.

In the example embodiment shown in FIG. 1, recirculation tube 42 comprises an essentially U-shape assembly comprising three segments: vertical downflow segment 60; horizontal segment 62; and vertical upflow segment 64. The recirculation tube 42 serves to receive the treated (e.g., desalinized) water from condensation chamber 38, and to cool a recirculation portion of the treated water, and then to admit the recirculation portion of the treated water back into nozzle 36. At least a portion of tube 42 extends through housing 22 and into the body of input water 24. In this regard, FIG. 1 shows both vertical downflow segment 60 and horizontal segment 62 as extending through unillustrated sealed ports on a bottom side of housing horizontal compartment 26 and extending vertically down into the body of input water 24.

As mentioned above, discharge mechanism 56 is provided and configured to discharge at least some of the treated water (e.g., treated water other than the recirculation portion) so that the treated water can be extracted from desalinization system 20. In the example embodiment of FIG. 1, discharge mechanism 56 is situated in an upper portion of vertical downflow segment 60 of recirculation tube 42. The discharge mechanism 56 can take the form of a port, and preferably a valved port, as well as discharge tube 66. In the example illustrated embodiment, discharge mechanism 56 particularly takes the form of a rotary lock valve. FIG. 1 shows by arrow 68 the discharge of desalinized water through residue reservoir 66 upon opening of the rotary lock valve comprising residue reservoir 66. It will be appreciated that additional apparatus can also be provided for supplying purification or other treatment chemicals and/or minerals (e.g. chlorine or fluorine or anti-bacterial agent to the treated water in accordance with desired ultimate use of the treated water.

The evaporation chamber 34 can be provided with a residue reservoir 72 to collect solids which form upon evaporation of the heated input water, e.g., salt. The residue reservoir 72 can be accessed or comprise features that enable residue reservoir 72 to be serviced for removal of the solids that are formed or deposited therein.

In the example embodiment of FIG. 1, nozzle 36 is configured to accelerate the passage of the moist vapor therethrough. In this regard, nozzle 36 can have a tapered or horn-shaped nozzle interior passage 74 which is contoured to provide a venturi effect type of transmission of the moist vapor therethrough. As a desired optional feature nozzle 36 comprises at least one rotatable turbine situated in the nozzle interior passage 74. In this regard, in the particular example embodiment of FIG. 1 the nozzle 36 is provided with a first (larger) or “entrance” turbine 76 and a second (smaller) or “exit” turbine 78. The sizes of entrance turbine 76 and exit turbine 78 are dependent upon the cross sectional area of nozzle interior passage 74 at the positions of turbine placement. The entrance turbine 76 and exit turbine 78 are configured to rotate as the moist vapor is transported thereby and accordingly to generate electricity as the moist vapor travels through the nozzle. FIG. 1 essentially shows only impellers or blades of entrance turbine 76 and exit turbine 78. However, it should be understood that entrance turbine 76 and exit turbine 78 can comprise, or be connected to, electrical generation apparatus such as conventionally known rotor and stator power generation mechanisms.

In an example implementation, water heater 30 comprises a vacuum-tube array solar water heater. The vacuum-tube array solar water heater is shown by way of example in FIG. 1 as having a serpentine or radiator-like internal path through which the input water can travel from body of input water 24 to the outlet of water heater 30 (which connects to connector pipe 50).

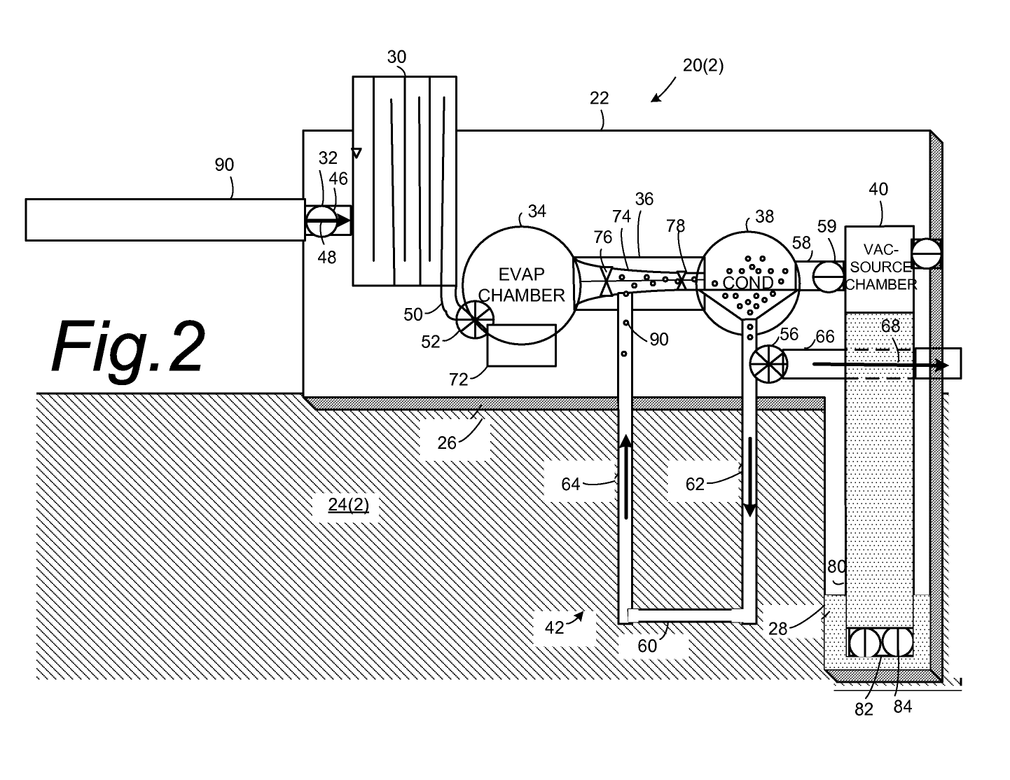

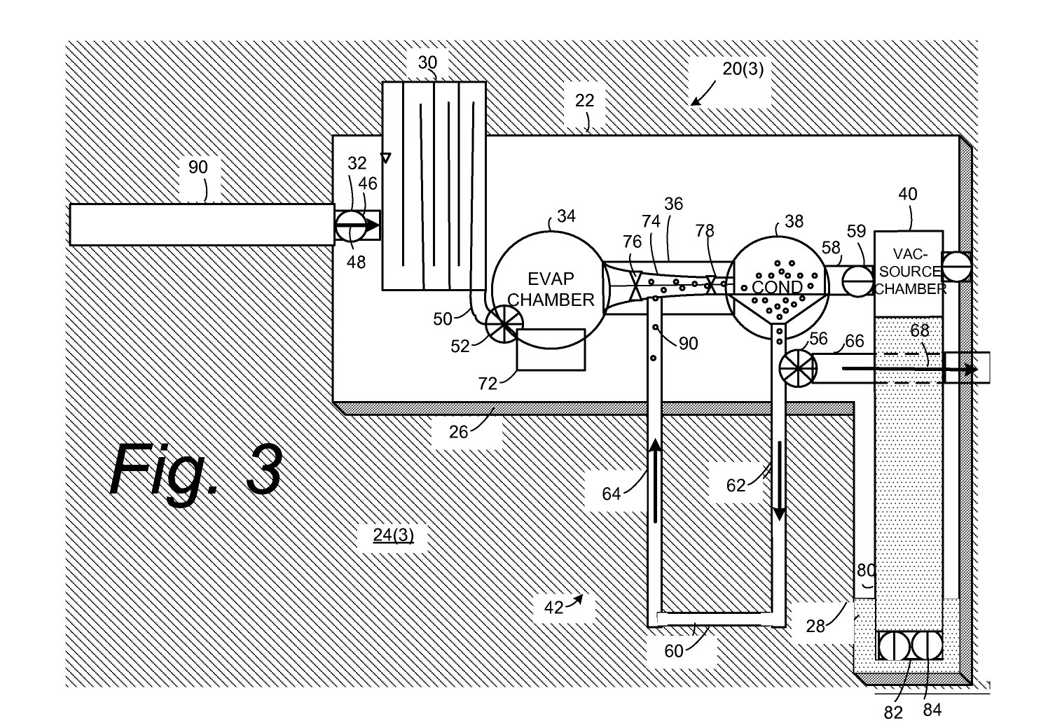

In an example embodiment, vacuum source 40 comprises a Torricelli vacuum source. In such embodiment the Torricelli vacuum source comprises a column of liquid 80, a majority of the column of liquid 80 being situation in the vertical section and below the first depth D1. As an optional feature, this embodiment may further comprise a valving system 82 comprising at least one valve 84 configured to maintain the vacuum in the column of liquid 80.

Whereas the treatment system of FIG. 1 is particularly can, in one mode of implementation, be situated (e.g., partially immersed) in the body or source of input water (e.g., salt water body 24 in the case of FIG. 1), FIG. 2 and FIG. 3 illustrate respective treatment systems 20(2) and 20(3) which can be remote and/or inland from the body or source of input water. Constituent elements and or aspects of treatment system 20(2) and treatment system 20(3) which are similar to those of treatment system 20 FIG. 1 are depicted with similar reference numerals, although in some cases the reference numerals may be parenthetically suffixed to represent the embodiment of FIG. 2 and FIG. 3, respectively.

In the FIG. 2 and FIG. 3 embodiments, the input impotable water can be salty water or polluted water which is pumped or otherwise transported to the inland location of treatment system 20(2). In this regard, FIG. 2 shows a conduit or pipe through which input water may be supplied from an input water source to treatment system 20(2), and particularly to inlet 32.

FIG. 2 shows treatment system 20(2) and particularly housing horizontal compartment 26 as being situated predominately above-ground, with the ground or earth being depicted by hatched lines and reference numeral 24(2) in FIG. 2. Moreover, as shown in FIG. 2, portions of recirculation tube 42 and the vertical housing segment housing vertical compartment 28 can extend into depths of the earth for, e.g., cooling or pressure purposes.

The FIG. 3 embodiment of water treatment system 20(3) is substantially completed submerged or situated below ground, with the ground or earth also being depicted by hatched lines and reference numeral 24(3) in FIG. 3.

In another of its aspects, the technology comprises a method of treating impotable water. The method comprises the example acts of heating input water; vaporizing the heated input water (e.g., in evaporation chamber 34) to form a moist vapor; transmitting the moist vapor through a nozzle (e.g., nozzle 36) and into a condensing chamber (e.g., condensation chamber 38); condensing the moist vapor received from the nozzle to form treated water (e.g., desalinated or purified water); discharging at least some of the treated water; using a vacuum source (e.g., vacuum source 40) to draw the moist vapor through the nozzle and into the condensation chamber; and, recirculating and cooling a recirculated portion of the treated water from the condensation chamber and admitting the recirculation portion of the treated water into the nozzle.

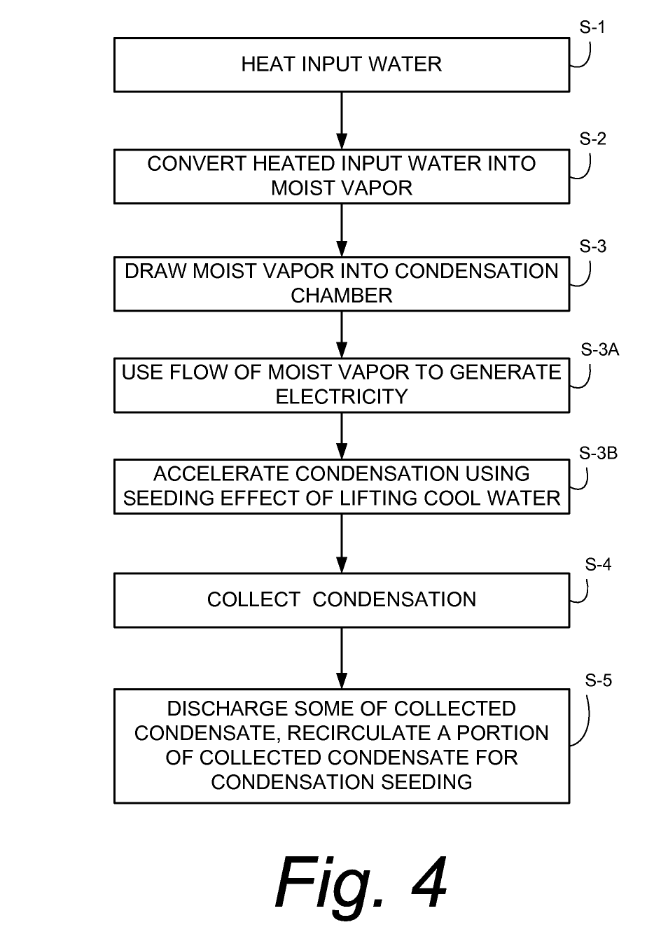

Variations and enhancements of the basic method (employed individually and collectively) are also provided. For example, in example mode, the method further comprises using a shape of the nozzle to accelerate passage of the moist vapor through the nozzle. In another example mode, the method further comprises situating at least one rotatable turbine in the nozzle and using the turbine to generate electricity as the moist vapor travels through the nozzle. In an example mode, the method further comprises using a vacuum-tube array solar water heater for heating the input water. FIG. 4 illustrates example, representative, basic acts or steps of an mode of implementing processes such as those practicable by way of the apparatus/systems of FIG. 1, FIG. 2, and other embodiments encompassed hereby. In an example implementation, the process starts with the entire system in a near vacuum. The vacuum that enables this system to work is maintained by creating a Torricelli vacuum (e.g., by vacuum source 40) to which the rest of the apparatus is attached. As act S-1 of FIG. 4, of the process, input water is first fed (via inlet 32) into and heated in water heater 30 (which preferably is a tube-array solar heater that is pressurized to prevent the water from expanding into gas as it is heated). The use of a vacuum heater allows the water to greatly exceed the sea-level boiling point of 212 degrees and to rise to a temperature of 500 degrees. Using rotary lock valve 52, this super hot, pressurized water is fed in small rapid bursts into evaporation chamber 34, e.g., a chamber that is maintained at near vacuum conditions. The significance of this is that water boils at 212 degrees at sea level. In a vacuum it boils at 82 degrees. This water is 500 degrees and if the amount of water is small enough, the vacuum great enough, and the chamber large enough it will convert to steam immediately upon entering the chamber. That is, the extremely hot input water is fed into the evaporation chamber 34 and flashes to vapor in the vacuum. This conversion of the heated input water into steam, e.g., into moist vapor is depicted as act S-2 in FIG. 4. As the water evaporates, the salt and/or other impurities remain as solids and fall to a collector at the bottom of the chamber (e.g., residue reservoir 72.

The vapor in evaporation chamber 34 creates a positive pressure in evaporation chamber 34. As act S-3, the vacuum of the condensation chamber (generated by vacuum source 40) draws the moist vapor from the now-positive atmosphere of the evaporation chamber 34 into itself through the nozzle 36 that separates the two chambers, e.g., separates evaporation chamber 34 and condensation chamber 38.

As an optional step S-3A, inside nozzle 36 one or more turbine-type generators (e.g., entrance turbine 76 and exit turbine 78) generate electricity as its/their blades are turned by the steam passing from the evaporation chamber 34 to the condensation chamber 38. As the moist vapor enters nozzle 36, the moist vapor turns entrance turbine 76. As it passes over the port through which vertical upflow segment 64 of recirculation tube 42 communicates with nozzle 36, the traveling moist vapor creates a lift which draws cool drops of treated water into the mist, thereby causing the condensation process to accelerate. The shape of nozzle 36, e.g., the contour of nozzle interior passage 74, creates additional acceleration which turns the exit turbine 78.

Thus, two forces work to propel the blades of the turbine (e.g., of entrance turbine 76 and exit turbine 78). The first is the pressure variance between the two chambers (e.g., between evaporation chamber 34 and condensation chamber 38), mentioned above. This initiates the flow through the turbine in the nozzle. The second force that propels the blades is generated within the nozzle 36. The vapor is made to condense as it passes through the nozzle 36. To cause this condensation, one end of U-shaped tube 42 (i.e., vertical upflow segment 64) is coupled for communication to the interior of nozzle 36. The end of vertical upflow segment 64 of recirculation tube 42 is filled with cold, fresh water which has been recirculated through cooler waters approximately 30 feet below the apparatus, e.g., below housing horizontal compartment 26.

As the first force, the pressure differential, draws the water vapor over the end of the vertical upflow segment 64 of tube 42 in the nozzle 36, the motion of the gas over the port of vertical upflow segment 64 creates lift for the treated water in recirculation tube 42. This lift causes cold droplets of water (illustrated as droplets 90 in FIG. 1) to rise and mix in the vapor, which actually accelerates the condensation of the vapor. This condensation leads to more flow which leads to more cold water lifting or rising, which in turn leads to more condensation, and the cycle repeats—each time gaining speed and power. Because the speed is so great, the flow through these kinds of nozzles is often measured in multiples of the speed of sound, Mach. This acceleration of condensation using an effect of lifting cool water lift is illustrated as act S-3B in FIG. 4.

The newly condensed, now fresh, water (e.g., desalinized or purified water) collects at the bottom of the condensation chamber 38, e.g., at the top of the U-shaped tube 42. Act S-4 shows reflects collection of condensation. The moist vapor essentially completely condenses in condensation chamber 38 and falls into the opening of recirculation tube 42 (e.g., into an opening of vertical downflow segment 60 of recirculation tube 42). A portion of the treated water thus condensed can be discharged, and another portion (the “recirculation portions”) continues to travel downwardly in vertical downflow segment 60, being cycled into cooler deeper waters (e.g., of body of salt water 24) to be used for seeding condensation in further cycles.

As freshwater collects in the condensation chamber 38, a portion thereof is removed or discharged by any of several methods, such as a rotary lock valve which, in the illustrated embodiment, comprises discharge mechanism 65. The discharge of desalinized water is reflected by act S-5 in FIG. 4. The rotary lock valve captures the newly-distilled water and maintains useful atmospheric pressures in the system. The rotary lock valve removes the new fresh water at the same pace that input water is added to the system. Control of the admission and discharge of fluids into treatment system 20 can be accomplished using a processor or controller or the like. The functions of the various elements including functional blocks labeled or described as “processors” or “controllers” or “computer(s)” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage. In any event, adding and removing fluid at a same rate maintains the atmospheric balances in desalinization system 20. The vacuum source 40 may be maintained by cycling open and shut the valves 84 of valving system 82 provided at the bottom end of water column 80.

As the water at the top end of vertical upflow segment 64 of recirculation tube 42 is lifted into the steam, that water creates a flow in tube 42 that draws the new fresh water down into tube 42. The vertical downflow segment 60 of recirculation tube 42 runs downward into the cooler regions of the source water (ocean, lake, sea, etc.), which keeps the water cool enough to seed more condensation as it flows through the cooling tube 42 into nozzle 36, through the generator, and back into the condensation chamber 38 where it starts the process again or is removed from the system as clean water.

Depending upon implementation, in a variation or alternate embodiment it is possible to open and close the chambers using valves to allow each step to process completely. Another variation comprises several evaporation chambers matched with respective condensation chambers that alternately feed vapor through one nozzle to maintain a constant force against the turbine blades.

Thus, as evident from the foregoing, apparatus and method are provided for treatment of impotable and for optionally simultaneously creating surplus electricity. Briefly, water is marshaled through a series of chambers by variances in pressure which are created as the water changes state from liquid to gas and from gas to liquid. The source water moves through the system, first heated, then vaporized where the impurities fall out, then pushed and pulled through a nozzle where it turns the blades of a turbine-type generator, and finally condensed where the newly-distilled water is removed from the system.

Reference was made above to a Torricelli vacuum. In this regard, the vacuum in the evaporation chamber is maintained by using the principle discovered by Evangelista Torricelli in 1607. He created the first sustained vacuum by filling a four-foot-long tube with mercury and then inverting it into a container of mercury. Not all of the mercury flowed out of the tube and the weight of the mercury left in the tube created a vacuum in the space above that mercury. In this case, a column of water is raised above the surrounding water by more than 10 meters creating a vacuum at the top of the column. It is this vacuum that enables the lower-temperature steam to develop as well as to feed the steam through the power-generating nozzle and into the condensation chamber.

Reference was also made above to gaining of speed and power. This energy is called enthalpy. Enthalpy denotes the heat content of a substance that is available to do work. In this case the substance is water and all of the energy that was required to change the water to a vapor (which is substantial) is captured instantly when the vapor reverts to liquid, or condenses. A kilogram of water requires 314 kilojoules to heat it from 25 degrees Celsius to 100 degrees and another 3,140 kilojoules to convert the water at 100 degrees to a vapor. This converts to about one kilowatt hour which is captured as the gas condenses. A kilowatt hour is the amount of power used when burning ten 100-watt bulbs for an hour or running a 3,000 watt air conditioner for twenty minutes.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for treating impotable water comprising:
a water heater;
an inlet configured to admit input water into the water heater;
an evaporation chamber, the evaporation chamber comprising an evaporation chamber inlet and an evaporation chamber outlet, the evaporation chamber being fed with heated input water from the water heater through the evaporation chamber inlet and wherein the evaporation chamber is configured so that the heated input water vaporizes therein to form a moist vapor;
a nozzle connected to the outlet of the evaporation chamber and configured for passage of the moist vapor therethrough;
a condensation chamber connected to receive the moist vapor from the nozzle and configured for treated water to condense therein;
a vacuum source connected to draw the moist vapor through the nozzle and into the condensation chamber;
a tube connected and configured to receive a recirculation portion of the treated water from the condensation chamber, to cool the recirculation portion of the treated water, and to admit the recirculation portion of the treated water into the nozzle.

2. The system of claim 1, wherein the impotable water is salt water, and wherein the inlet configured to admit the input water from a body or source of salt water.

3. The system of claim 1, wherein the impotable water is polluted water, and wherein the inlet configured to admit the input water from a body or source of polluted water.

4. The system of claim 1, further comprising a housing configured to at least partially enclose the water heater, the evaporation chamber; the nozzle, the condensation chamber, the vacuum source, and the tube, the housing being configured for at least partial submersion in a source of input water, and wherein at least a portion of the tube extends through the housing and into the source of input water.

5. The system of claim 1, further comprising a housing configured to at least partially enclose the water heater, the evaporation chamber; the nozzle, the condensation chamber, the vacuum source, and the tube, the housing being configured for at least partial submersion below ground.

6. The system of claim 1, wherein the nozzle is configured to accelerate the passage of the moist vapor therethrough.

7. The system of claim 6, further comprising at least one rotatable turbine situated in the nozzle and configured to rotate and generate electricity as the moist vapor travels through the nozzle.

8. The system of claim 1, wherein the salt water heater comprises a vacuum-tube array solar water heater.

9. The system of claim 1, wherein the vacuum source comprises a Torricelli vacuum source.

10. The system of claim 9, further comprising:
a housing, the housing comprising a horizontal compartment and a vertical compartment, the horizontal compartment extending to a first depth relative to a surface of the body of salt water, the vertical compartment extending to a second depth relative to a surface of the body of salt water, the second depth being greater than the first depth;
wherein the salt water heater, the evaporation chamber; the nozzle, and the condensation chamber are essentially situated in the horizontal section; and
wherein the Torricelli vacuum source comprises a column of liquid, a majority of the column of liquid being situation in the vertical section and below the first depth.

11. The system of claim 10, further comprising at least one valve configured to maintain the vacuum in the column of liquid.

12. The system of claim 9, further comprising:
a housing, the housing comprising a horizontal compartment and a vertical compartment, the horizontal compartment extending to a first depth relative to ground level, the vertical compartment extending to a second depth relative to ground level, the second depth being greater than the first depth;
wherein the water heater, the evaporation chamber; the nozzle, and the condensation chamber are essentially situated in the horizontal section; and
wherein the Torricelli vacuum source comprises a column of liquid, a majority of the column of liquid being situation in the vertical section and below the first depth.

13. A method of treating impotable water comprising:
heating input water obtained in a water heater;
vaporizing the heated input water in an evaporation chamber to form a moist vapor;
transmitting the moist vapor through a nozzle and into a condensing chamber;
condensing the moist vapor received from the nozzle to form treated water and discharging at least some of the treated water;
using a vacuum source to draw the moist vapor through the nozzle and into the condensation chamber;
recirculating and cooling a recirculated portion of the treated water from the condensation chamber and admitting the recirculation portion of the treated water into the nozzle.

14. The method of claim 13, wherein the impotable water is salt water.

15. The system of claim 13, wherein the impotable water is polluted water.

16. The method of claim 13, further comprising using a shape of the nozzle to accelerate passage of the moist vapor through the nozzle.

17. The method of claim 16, further comprising situating at least one rotatable turbine in the nozzle and using the turbine to generate electricity as the moist vapor travels through the nozzle.

18. The method of claim 13, further comprising using a vacuum-tube array solar water heater for heating the input water.
